(19) United States
(12) Patent Application Publication
(10) Pub. No.: US 2023/0175303 A1
(43) Pub. Date: Jun. 8, 2023

(54) FORCE PROFILE SETTING WHILE IN LIMIT SET MODE SYSTEMS AND METHODS

(71) Applicant: GMI Holdings, Inc., Mt. Hope, OH (US)

(72) Inventors: Gregory D. Matias, Copley, OH (US); Brent A. Rauscher, Keller, TX (US)

(21) Appl. No.: 18/072,440

(22) Filed: Nov. 30, 2022

Related U.S. Application Data
(60) Provisional application No. 63/285,654, filed on Dec. 3, 2021.

(51) Int. Cl. E05F 15/668

(52) U.S. Cl. CPC E05F 15/668; E05Y 2201/434; E05Y 2400/31; E05Y 2400/40; E05Y 2400/32; E05Y 2400/36; E05Y 2400/85; E05Y 2900/106

(57) ABSTRACT

A barrier operator includes a motor, a controller operably connected to the motor, a sensor, and a control module. The motor is couplable to a drive mechanism of a barrier and is configured to move the barrier between open and closed positions. The sensor is configured to monitor an operating parameter of the barrier operator associated with movement of the barrier. The control module includes user input controls. The controller is configured to receive a first user input from the control module; initiate, in response to receipt of the first user input, operation of the motor for a first movement of the barrier to establish a first travel limit of the barrier; receive a first signal indicative of the operating parameter from the sensor; and generate, during the first movement of the barrier, a first force limit based on the first signal from the sensor.

### PRIORITY INFORMATION

This application claims the benefit of U.S. Provisional Application No. 63/285,654 filed Dec. 3, 2021 and entitled “Force Profile Setting While in Limit Set Mode Systems and Methods,” the disclosure of which is hereby incorporated by reference in its entirety.

### FIELD

The present disclosure is directed to remotely controlled barrier operator systems for opening and closing garage doors, gates and other barriers, and more particularly to systems and methods for setting a force profile for such barrier operator systems.

### BACKGROUND

With few exceptions, barrier operator systems, such as those controlling upward acting sectional garage doors, rollup doors, gates, and other motor operated barriers, may be remotely controlled. Typically, they are remotely controlled by one or more wired or wireless building mounted or wireless hand-held remote transmitters. These transmitters, upon actuation by a user, typically send encrypted access codes and commands to a receiver associated with the barrier operator. A controller unit also associated with the barrier operator then receives and decrypts the data. Upon receiving the data and verifying an access code, a barrier operator then moves or stops the barrier, depending upon the command and/or a current operating state.

There have been developments wherein, as a safety measure, the operator controller will automatically set maximum door closing and opening force limits to a predetermined value when an external entrapment device is present and connected to the controller, and a controller may set force limits to a lower value when an external entrapment device is not present. The force limits may be compared to current forces measured or calculated during barrier movement to detect when the barrier has encountered an obstacle. However, there are situations wherein the user of the barrier or door may need to set or revise the force limits such as, for example, when the operator is initially installed, when the barrier guide structure becomes bent or otherwise out of position requiring the door operator to exert greater forces to move the barrier, or when the barrier weight has changed or the barrier is not capable, for various reasons, of being properly balanced or counterweighted. Under such circumstances it is desirable to allow the user to adjust the force limits. However, existing operators may require an external entrapment device to be operably connected to the door controller to establish force limits. In some situations, an external entrapment device may not be present, may not be functional, or it may otherwise be impractical to establish force limits while an external entrapment device is connected.

Therefore, there is a need for barrier operator systems and methods that provide greater flexibility in system configuration and timing when programming a force profile for barrier operator systems.

### SUMMARY

Consistent with some examples, a barrier operator for moving a barrier includes a motor, a controller, a sensor, and a control module. The motor is couplable to a drive mechanism of a barrier and is configured to move the barrier between open and closed positions. The controller is operably connected to the motor. The sensor is configured to monitor an operating parameter of the barrier operator associated with movement of the barrier. The control module includes user input controls and is in operative communication with the controller. The controller is configured to: receive a first user input from the control module; initiate, in response to receipt of the first user input, operation of the motor for a first movement of the barrier to establish a first travel limit of the barrier; receive a first signal indicative of the operating parameter from the sensor; and generate, during the first movement of the barrier to establish the first travel limit, a first force limit based on the first signal from the sensor.

In some examples, the first user input may be a sustained input detected by the user input controls. The controller is further configured to cease operation of the motor upon termination of the sustained input. The user input controls may include a button. The sustained input may be an extended press of the button.

In some examples, the sensor may be a force sensor and the operating parameter may be a force required to move the barrier. The first force limit may be a force profile including a plurality of forces required to move the barrier during the first movement of the barrier. Each force of the plurality of forces may correspond to a respective position of the barrier. The first force limit may be a single value based on a maximum force required to move the barrier during the first movement of the barrier.

In some examples, the sensor may be a current sensor and the operating parameter may be a current supplied to the motor to move the barrier during the first movement of the barrier. The controller may be further configured to determine a force required to move the barrier based on the current supplied to the motor. The first force limit may be a current profile including a plurality of currents supplied to the motor during the first movement of the barrier. Each current of the plurality of currents may correspond to a respective position of the barrier. The first force limit may be a single value based on a maximum current supplied to the motor during the first movement of the barrier.

In some examples, the sensor may be a position sensor and the operating parameter may be a velocity of the barrier during the first movement of the barrier. The first force limit may be a velocity profile including a plurality of minimum velocities corresponding to a plurality of positions of the barrier. The first force limit may be a single value based on a minimum velocity of the barrier during the first movement of the barrier.

In some examples, the first signal may be a continuous stream of information transmitted by the sensor to the controller during the first movement of the barrier.

In some examples, the controller may be further configured to generate a second force limit based on the first force limit. The second force limit may correspond to movement of the barrier in a direction opposite to a direction of the first movement of the barrier.

In some examples, the controller may be further configured to receive a second user input from the control module; initiate, in response to receipt of the second user input, operation of the motor for a second movement of the barrier to establish a second travel limit of the barrier; receive a second signal indicative of the operating parameter from the sensor; and generate, during the second movement of the barrier to establish the second travel limit, a second force limit based on the second signal from the sensor.

In some examples, the first movement of the barrier may be an opening movement beginning from a closed position of the barrier. The first travel limit may be an open limit position of the barrier. The first user input may be a momentary input.

In some examples, the first movement of the barrier may be a closing movement beginning from an open position of the barrier. The first travel limit may be a closed limit position of the barrier.

In some examples, the controller may be further configured to monitor the operating parameter during movement of the barrier subsequent to the first movement of the barrier; compare the operating parameter during the movement of the barrier subsequent to the first movement of the barrier to the first force limit; and cease operation and/or reverse a direction of rotation of the motor when the operating parameter exceeds the first force limit. In some examples, when a force limit is exceeded while the barrier is moving toward a closed position, the controller may reverse the direction of rotation of the motor to open the barrier. When a force limit is exceeded while the barrier is moving toward an open position, the controller may cease operation of the motor to stop the barrier.

Consistent with some examples, a method for establishing a force limit for a barrier operator includes: receiving a first user input from a control module of a barrier operator; initiating, in response to receipt of the first user input, operation of a motor of the barrier operator for a first movement of a barrier to establish a first travel limit of the barrier; receiving a first signal indicative of an operating parameter of the barrier operator from a sensor; and generating, during the first movement of the barrier to establish the first travel limit, a first force limit based on the first signal from the sensor.

Other examples include corresponding methods, computer systems, apparatus, and computer programs recorded on one or more computer storage devices, each configured to perform the actions described herein.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a perspective view of an installed barrier operating system including an upward acting sectional garage door in accordance with an example of the present disclosure.

FIG. 2 is a block diagram of a barrier operating system in accordance with an example of the present disclosure.

FIG. 3 is a flow chart illustrating an example method of operation of a barrier operator in accordance with an example of the present disclosure.

FIG. 4 illustrates a force limit according to an example of the present disclosure.

FIG. 5 illustrates a force limit including a force profile according to an example of the present disclosure.

FIG. 6 illustrates another example of a force limit including a force profile according to an example of the present disclosure.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The devices and techniques disclosed in this document may be used to enhance the process of establishing or revising force limits in barrier operating systems. The disclosed devices and techniques may provide alternatives to use of an external entrapment device during programming of force limits. In some implementations, force limits may be established earlier in the setup process or a barrier operator which provides for reduced setup time and expedited normal operation.

In the following description, like elements are marked throughout the specification and drawings with similar reference numerals. The drawing figures are not necessarily drawn to scale and certain elements are shown in generalized or schematic form in the interest of clarity and conciseness. It should be understood that the embodiments of the disclosure herein described are merely illustrative of the principles of the invention.

Some known barrier operator systems may be configured to operate in a setup mode (or “safety mode”) upon initial activation during installation. The setup mode may also be invoked after installation when the controller identifies a need for adjustment due to a change in conditions or the user manually enters the setup mode. A barrier operator may operate in the setup mode until one or more travel limits and/or one or more force limits have been established. Upon these limits being established, the barrier operator may transition to a normal operating mode.

In the setup mode, operating properties of the barrier operator may be modified as compared to the normal operating mode. For example, a maximum velocity of the barrier or a maximum force applied by the motor may be reduced to improve safety and reduce the risk of injury. In some known systems, a user may be prompted or instructed to first set travel limits of the barrier. This process may involve pressing an up button on a control module of a barrier operator's user interface. The barrier then travels upward while the user is pressing the button. Upon reaching the fully open position, the user releases the button and the barrier stops. The stopped position of the barrier is stored in memory of the barrier operator as the “open” position travel limit. The process may then be repeated for the downward direction and “closed” position travel limit. Although described in relation to a button, it will be appreciated that any suitable user input control may be used, including but not limited to, a touchscreen, a capacitance sensor, a switch, a dial, etc.

Once the travel limits are established, the user may be prompted to cycle the barrier operator with a wall mounted control console or a wireless remote. During this initial cycle of the barrier, one or more force limits are established by the barrier operator monitoring one or more operating parameters as the barrier is moved. The term “operating parameter” as used herein refers to any property of the barrier operator system that varies over time or over the course of travel of a barrier and which may be monitored by a sensor, calculated by the controller using an algorithm, or otherwise determined by the barrier operator. The one or more operating parameters relate to the force applied to move the barrier or some other property related thereto. The initial cycle of the barrier operator is assumed to be a “successful run” in that an installer or user will have been actively interacting with the barrier operator system (e.g., to set travel limits) and can remove any obstructions from the path of the barrier. Accordingly, the operating parameters observed during this initial cycle may be considered indicative of a successful run and used to establish one or more force limits. These force limits may be compared to one or more operating parameters during each subsequent barrier run during normal use of the barrier operator to detect obstructions so that the barrier may be stopped or reversed. Because the one or more operating parameters used to establish the force limits are related to the force applied to move the barrier, it will be appreciated that the term “force limit” as used herein may refer to a force, but may also refer to a motor current, a motor torque, a velocity of the barrier, an angular velocity of a shaft of the motor, or any operating parameter that is related to an output force of the motor.

Upon completion of establishing travel limits and force limits, the barrier operator may transition to the normal operating mode. In this regard, the door may be operated via a wall mounted control console or a wireless remote and will be configured to operate at a normal operating velocity as compared to the reduced velocity initially used during the setup mode. When operating in the normal mode, the barrier operator continues to monitor one or more operating parameters and compares the one or more operating parameters to the one or more force limits. When an operating parameter exceeds a force limit, the barrier operator may infer an anomaly has occurred such as an obstruction in the path of the barrier, the barrier has become jammed, a guide track on which the barrier travels has been bent or damaged, etc. Such an anomaly may be addressed by stopping travel of the door or reversing the direction of travel.

It will be appreciated that prior to establishing force limits, a barrier operator may have a reduced ability to detect obstructions based on the forces required to move the barrier being unknown. That is, until the barrier operator has cycled through an initial run during which operating parameters may be monitored and recorded, the barrier operator has little or no information regarding expected forces that will be encountered during barrier travel. A variety of factors may influence the forces needed including the weight of the barrier, friction losses, radii of curvature of a guide track, etc. In this regard, encountering an obstruction or other anomaly during an initial cycle of the barrier may be undetectable as the barrier operator may interpret an additional amount of force being needed as corresponding to normal resistance in the system.

Accordingly, the present disclosure contemplates a barrier operator and associated methods for establishing one or more force limits while providing a safety mechanism to reduce the likelihood of injury to individuals in the vicinity of the barrier caused by force requirements being unknown to the barrier operator. The disclosed embodiments may provide additional advantages including, but not limited to, a reduction in the time required to install and setup a barrier operator.

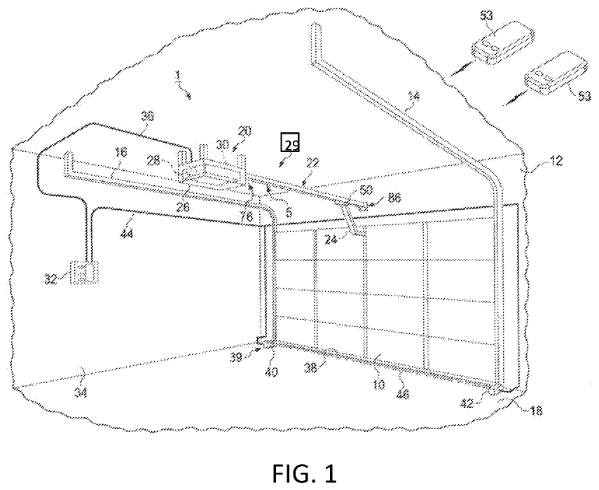

FIG. 1 illustrates a barrier operating system 1 including a movable barrier 10 comprising a sectional upward acting garage door movable between a closed position shown, covering an opening in a wall 12, and an open position guided between opposed sets of guide tracks 14 and 16. In the closed position of the barrier 10, it is typically in sealing engagement with a driveway or floor 18 or at least in close proximity to such a surface. Barrier 10 is movable between its open and closed positions by a motor driven operator 20 which may, in part, be of conventional construction. Operator 20 is disposed adjacent to a barrier drive mechanism 29 which may include: (i) an elongated beam or rail assembly 22 connected at one end 86 to wall 12 and at its opposite end 76 to the barrier operator head unit or housing 26; (ii) a drive assembly 5, which can be a reciprocatingly driven drive belt or chain or a rotatably driven screw drive, supported by the rail assembly 22, and (iii) a carriage 50 operably connected to the drive assembly 5. The carriage 50 is disconnectably engageable with arm 24 which, in turn, is connected to the barrier 10. Accordingly, motor 28, under control of the barrier operator 20, drives the belt, chain or rotatable screw in one direction or the other, consequently transporting the carriage 50 to respectively raise (open) or lower (close) the barrier 10. Controller 30 is operably connected to a wall console 32 suitably supported on a sidewall 34 in a conventional manner. Controller 30 and console 32 may be in communication with each other via hardwire conductor means 36 or via radio frequency communication. For example, the controller 30 and the wall console 32 may each have suitable radio frequency transceivers associated therewith, respectively, providing for communication between these two units. Further, hand held (or vehicle mounted) transmitters 53 may transmit encrypted RF transmissions representing door commands to the barrier operator 20.

FIG. 1 illustrates so-called external entrapment devices associated with the barrier or door 10. One external entrapment device comprises an elongated edge sensor 38 of a type known to those skilled in the art which is mounted on the lower edge of the barrier or door 10 and is operable, upon engagement with an obstruction in the doorway, to provide a signal to the controller 30 directly or via the console 32. A second type of external entrapment device 39 is illustrated which includes an optical or infrared beam transmitter 40 disposed on one side of the aforementioned opening or doorway and a receiver 42 disposed on the opposite side of such opening. Such a device is commonly referred to as a “safety beam” or “photo eye.” The transmitter 40 and receiver 42 are operable to send a signal to the controller 30, which may be by way of the console 32 via suitable wired or wireless conductor means 44, for example, if an obstruction breaks a radiation beam 46. The external entrapment device 39, comprising the beam transmitter 40 and receiver 42, may also be of a type known to those skilled in the art. Both external entrapment devices 38 and 39 may be used on a particular barrier or only one or none of such external entrapment devices may be required.

Although the illustrated example encompasses an upward acting sectional garage door and the associated hardware, it should be appreciated that the concepts described herein also apply to other movable barrier systems including one-piece upward acting doors, rollup doors, gates, and other motor operated barriers.

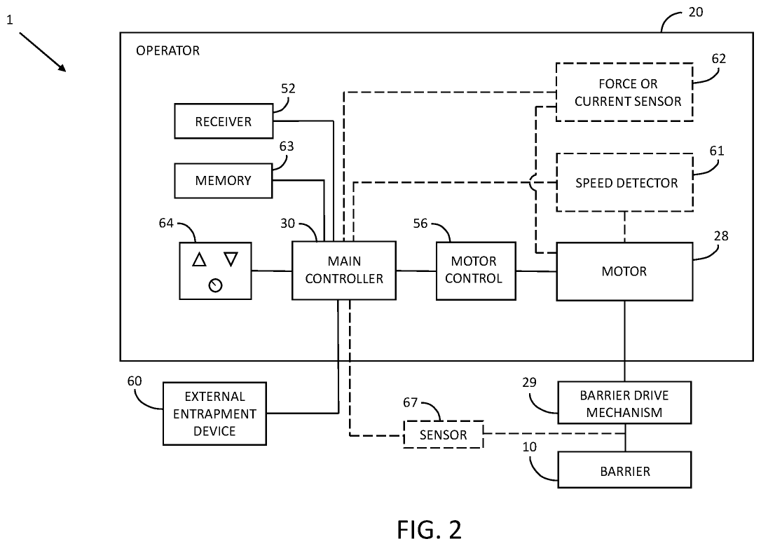

FIG. 2 illustrates a generalized schematic diagram of the barrier operator 20 and some of the other components described in FIG. 1. The barrier operator 20 includes a motor 28 which is connectable to a barrier drive mechanism 29. The barrier drive mechanism 29 may comprise a screw drive, chain, belt, jackshaft, etc., for moving the door or barrier 10 between open and closed positions. The controller 30 preferably includes a programmable processor operably connected to memory 63 and to a radio frequency receiver 52. Receiver 52 may also include a suitable transmitter for communicating with the wall console 32 and/or with remote control transmitters 53 of FIG. 1. The controller 30 may also be operably connected to a motor control circuit 56 which, in turn, is connected to the motor 28 enabling the controller 30 to control operation of the motor 28.

One or more operating parameters of the barrier operator system may be monitored by one or more of the motor control circuit 56, a speed detector 61, a force or current sensor 62, or a sensor 67. An operating parameter, such as electrical current being conducted to the motor 28, as required by the motor to operate the barrier drive mechanism 29 to move the barrier 10 between open and closed positions, may be sensed by suitable current or voltage sensing means included in the motor control circuit 56, for example. A signal corresponding to the magnitude of such current or voltage is transmitted to the controller 30 so that the magnitude of the current or voltage related to motor torque or driving effort can be continuously monitored by the controller 30. In this way the driving force of the motor 28 exerted when moving the door or barrier 10 between open and closed positions may be continuously monitored. An example of a motor control circuit wherein motor current is sensed to determine the driving effort of the motor and the force exerted on and by a barrier or door is described in U.S. Pat. No. 6,118,243 (entitled “Door Operator System”), which is incorporated by reference herein in its entirety.

Alternatively, or in addition, an operating parameter may be measured by a speed detector 61 of a type described in the aforementioned patent. Controller 30 is operable to receive signals indicating motor speed from speed detector 61. Electric motors typically generate a torque which is related to speed and if resistance to motor driving torque is encountered, speed will decrease and such speed change may be sensed to determine when a maximum barrier force is being exerted or would be exerted on an obstruction in the path of movement of the barrier.

Alternatively, or in addition, there is a correlation between electrical current supplied to motor 28 and the motor torque or effort being imposed on the barrier, and such current may be sensed by force or current sensor 62 and used as a signal to control operation of the motor 28. Still further, force or current sensor may include a strain gauge or other type of force transducer that may be associated with the door operator, such as the operator to provide a signal to the controller 30 to indicate when an obstruction is being encountered or if some fault in the door guide structure is being experienced or encountered, for example.

Alternatively, or in addition, an operating parameter may be measured by a sensor 67 disposed on the barrier drive mechanism 29, on the barrier 10, or somewhere therebetween. In some examples, the sensor 67 may be a position sensor which determines a current position of the barrier 10. The position of the barrier 10 over time, as determined by the sensor 67 may be used to calculate a velocity of the barrier 10.

Whether using one or more of motor control circuit 56, speed detector 61, force or current sensor 62, or sensor 67, the controller 30 may operate to cause the motor 28 to reverse and drive the barrier in the opposite direction, for example, or simply shut off to prevent a catastrophic event (e.g., damage the barrier system, damage to an obstacle, or injury to a person). Typically, for barriers such as residential garage doors, if the door is moving in the direction to close and an obstruction is encountered, the increase in motor torque related to a speed decrease or increased current flow can be sensed to cause the motor control unit to stop the motor and reverse its direction to move the barrier to an open position. If the barrier is moving toward an open position and an obstruction is encountered, the motor 28 may be controlled to simply shut off.

As described above, the actual forces applied by the motor 28 may be directly measured (e.g., with a strain gauge) or inferred from other operating parameters such as motor current, angular velocity of a motor shaft, velocity of the barrier, etc., associated with the barrier operator 20. One or more of these operating parameters may provide a signal, a limiting value (“force limit”) of which may be utilized by the controller 30 to effect operation of the motor 28 in the event of an anomaly. One or more such force limits may be established through interaction with control module 64 of the barrier operator 20. The control module 64 may comprise a user interface with one or more user input controls such as pushbuttons, switches, knobs, dials, touchscreens, indicator lights, and the like, through which a user may locally provide instructions to the controller 30, including during the setup mode to establish travel limits and force limits. The control module 64 is shown with two input buttons and a knob in the example in FIG. 2. An additional example includes a programming button that a user may press to indicate a travel limit has been set after moving the barrier via a first directional button (e.g., an “up” button) or a second directional button (e.g., a “down” button).

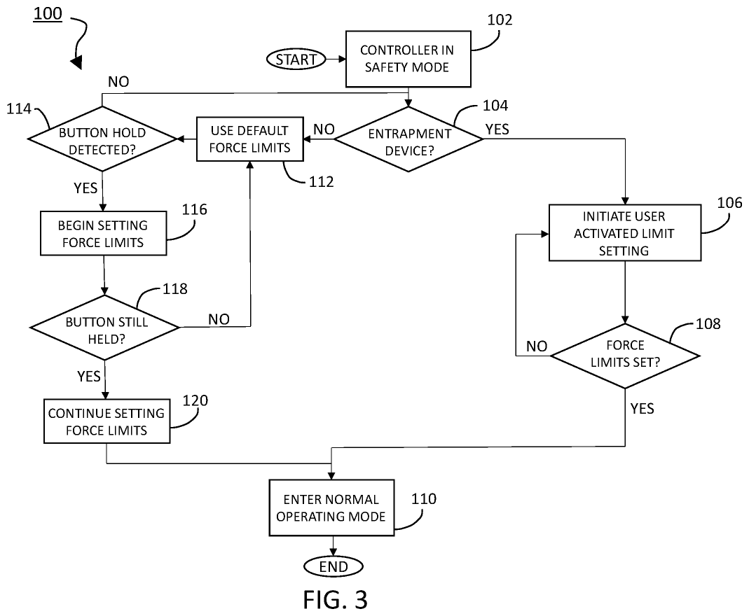

FIG. 3 illustrates a flow chart of an example of a method 100 for establishing force limits. Initially, at process 102, the barrier operator is in a safety or setup mode to reduce the likelihood of injury to individuals in the vicinity of the barrier. At a process 104, the controller determines whether an external entrapment device is connected to the barrier operator and operational to detect potential obstructions. If an external entrapment device is detected, at process 106, the user may initiate a procedure for establishing the force limits. This process may include cycling the barrier operator to move from the open position to the closed position, from the closed position to the open position, or both. During travel of the barrier, the controller may receive a signal from the one or more sensors (e.g., motor control circuit 56, speed detector 61, force or current sensor 62, or sensor 67) and generate one or more force limits based on the signal. It should be appreciated that “signal” as that term is used in this regard, may refer to a continuous stream of data that includes a current indication of the monitored operating parameter, such that the operating parameter may be continuously monitored by the controller over time, or may refer to a momentary or brief signal. For example, one or more of the sensors may be configured to transmit a signal to the controller periodically, with each change in a value of the operating parameter, or upon determining a maximum value. At process 108, it is determined whether the one or more force limits have been established. If not, the method returns to process 106 and awaits user input. If so, the controller may transition the barrier operator into the normal operating mode at process 110.

Alternatively, if no external entrapment device is detected at process 104, the method moves to process 112 at which the controller implements default force limits. These limits may be programmed during manufacturing may impart a lowest estimated maximum force limit to reduce the risk of injury. These force limits may also include a low maximum speed of the motor. In some example implementations, the low maximum speed may be set at a reduced speed as compared to movement when the user is providing a sustained input as described below in process 114. In some examples, process 112 may be omitted and the method may include rendering the motor inoperable until the force limits are set by a user beginning at process 114 or until an external entrapment device is detected.

At process 114, the controller determines if a sustained input has been received via the control module. In this regard, a “sustained input” may be an extended button press of a pushbutton of the control module or any other suitable indication that the user is present in the local vicinity of the barrier operator and is actively engaged in operating the barrier. That is, in this example, constant contact that is input by a user locally is required to execute the processes for establishing force limits. Accordingly, in a preferred embodiment, a user may not user a wireless remote device to operate the barrier operator while it is in the setup mode when an external entrapment device is not present. This may help ensure that a user has a line-of-sight of the barrier while it is moving prior to establishing force limits. While described herein in the context of constant contact with the control module of the barrier operator, in some examples, a controller may be configured to permit force limits to be established using a hard-wired wall console. In this regard, wall console 32 of FIG. 1 may include one or more pushbuttons, a touchscreen, switches, or other user input controls. A visual display may be used to indicate certain steps to be required of the user and/or certain values being input by the user, such as travel limits, force limits, or motor speed limits. Examples of user set force limits is described in U.S. Pat. No. 7,180,260 (entitled “Barrier Operator Controller with User Settable Control Limits When Entrapment Device Present”), which is incorporated by reference herein in its entirety.

When a button press is detected at process 114, the method advances to process 116 during which the barrier travels along the guide track or other path and the controller monitors and records one or more operating parameters. These operating parameters may be stored in memory of the barrier operator as force limits to be recalled and compared to operating parameters during subsequent use of the barrier operator. In some examples, the force limits are stored as a maximum threshold value and in some examples the force limits are stored as profiles as discussed further below. Process 118 determines whether or not the user is still in constant contact with the control module. If not, the motor will cease moving the barrier. That is, when the user releases the button, the motor (and therefore the barrier) stops movement. Movement occurs only while the button is pressed. In some examples, the controller may begin a waiting period to see if the user re-engages the button, in which case the method may continue. If the user does not re-engage the button within the waiting period, the method may return to process 112 and may optionally move the barrier to the open or closed position using the default force limits. If it is determined at process 118 that the user is still in constant contact, the method will continue to process 120 and continue setting the force limits. For example, the barrier will continue moving along its path until the user releases the button. Upon establishing a force limit for one direction of travel, processes 114-120 may be repeated for the opposing direction of travel. In some examples, these processes may only be required for one direction of travel (e.g., only when lowering the barrier). For example, the controller may infer force limits for the opposing direction of travel, apply an algorithm to convert the force limits for one direction into force limits for the other direction, or apply a default force limit for the other direction. Upon completion of process 120, the controller may transition to the normal operating mode at process 110. In examples in which force limits for only one direction are established in the setup mode, a first barrier cycle in the normal operating mode may be used to establish force limits for the opposing direction. Further, it will be appreciated that force limits may be refined over time by monitoring operating parameters during normal use. For example, as moving parts begin to wear, guide tracks become warped or worn, or lubrication begins to wear off, a controller may be configured to gradually revise the force limits appropriately. It should also be appreciated that the method 100 may incorporate processes 114-120 even when an external entrapment device is detected. For example, process 106 may include processes 114-120. As another example, process 106 as described above may be initiated by a wireless transmitter whereas process 114 may be initiated by interaction with a wired wall console or the control module of the barrier operator.

In accordance with the present disclosure, processes 114-120 may also include the establishment of travel limits. That is, sustained input from a user may cause the barrier to travel from the open position to the closed position or vice versa. During this travel, one or more operating parameters are monitored and force limits are established using these operating parameters. When the user provides an indication that the barrier has reached its travel limit in the given direction, for example by releasing the button for a period of time exceeding a waiting period or by pressing another button to indicate they have completed manual control of the barrier travel, the position of the barrier may be recorded as a travel limit. In this regard, a travel limit and a force limit may effectively be established concurrently. Advantageously, the method 100 of FIG. 3 may reduce the total time required for barrier operator setup by reducing the number of travel cycles or barrier runs needed to set the travel limits and force limits. Further, method 100 allows for the establishment of force limits without an external entrapment device while still providing for safe operation through constant contact of the user. In some implementations, instead of simultaneously setting the travel and force limits, the travel limits may be set using constant button press during upward and/or downward movement as described herein without the use of the entrapment devices, and then only after the travel limits are set, the force profile may then be created. Depending on the implementation, establishing the force profile after setting the travel limits may be accomplished using constant contact button press to raise or lower the barrier (in either one direction with inferred profile setting in the other direction or in both directions) while monitoring the parameters used to create the force profile as described herein.

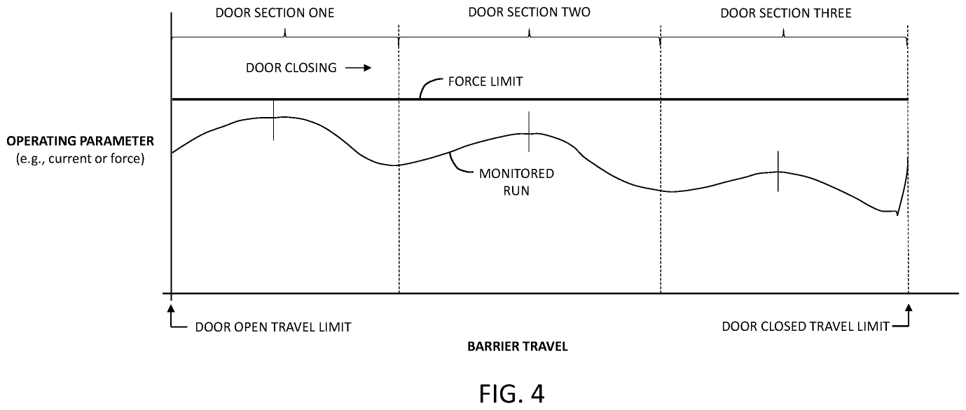

Turning to FIGS. 4 through 6, examples of the principals described herein related to force limits are further illustrated. FIG. 4 illustrates an operating parameter (e.g., current or force in the illustrated example) varying with distance of a barrier travel run in conjunction with a single value operating parameter limit (or “force limit”). Although illustrated as barrier travel from the open position to the closed position, it will be appreciated that these principals similarly apply to an opening movement. The example shown pertains to a sectional upward acting garage door having three panel sections. The operating parameter encounters local peaks pertaining to each panel section, the peaks indicated with short vertical lines in the illustration. For example, increased resistance may be encountered as wheels secured to the panel sections pass through a curved section of guide tracks between adjacent horizontal and vertical sections. This resistance may require the motor to exert additional force to maintain the speed of the barrier while moving through the curved section. Similarly, as the door reaches the closed position and contacts the floor, the operating parameter may begin to spike until the controller ceases operation of the motor as shown by the increase in current/force on the right side of the monitored run plot.

In the instance that the monitored run shown in FIG. 4 is a barrier run occurring during the steps of method 100, this plot or profile of the monitored run may be used to establish the illustrated force limit. In this instance, the controller identifies the greatest value of the operating parameter, in this case the local peak of panel section one, and sets the force limit slightly higher than that value. Although the force limit could alternatively be set equal to the greatest value of the operating parameter, such a configuration may be undesirable as the barrier operator would be exceedingly sensitive to perceived obstructions, stopping or reversing the motor unexpectedly or unnecessarily. By setting the force limit slightly higher than the greatest value of the operating parameter, the barrier operator may be better configured to accommodate small changes in experienced forces that may occur over time such as changes in temperature expanding or shrinking metal guide tracks, worn parts increasing friction, etc.

In the instance that the monitored run shown in FIG. 4 is a barrier run occurring subsequent to establishment of the force limit, the controller may compare the operating parameter of the monitored run to the force limit during the barrier travel. If the operating parameter were to exceed the force limit, that is the plot of the monitored run were to cross the force limit line, the controller would determine an anomaly has occurred and stop or reverse the motor.

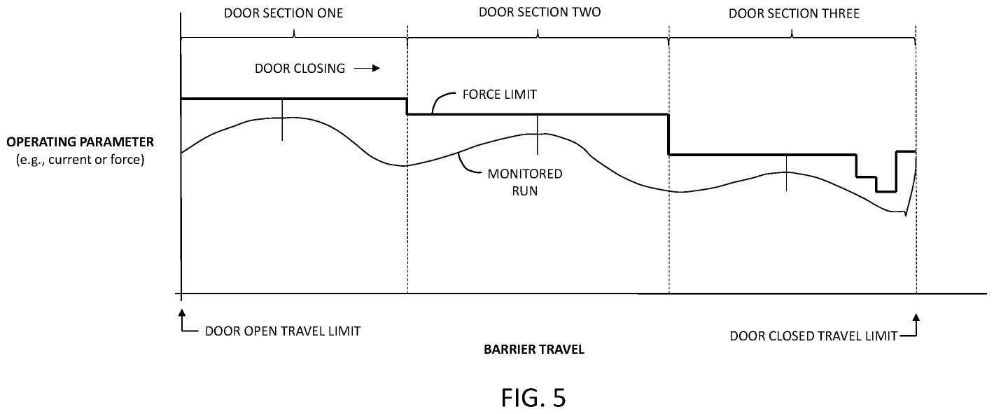

Turning to FIG. 5, a controller may be configured to establish a set of force limits comprising a “force profile” as opposed to the single value force limit illustrated in FIG. 4. Examples of the use of force profiles are described in U.S. Pat. No. 10,060,173 (entitled “Multiple Speed Profiles in Barrier Operator Systems”), which is incorporated herein by reference in its entirety. The illustrated example of FIG. 5 is similar to FIG. 4 except the force limit is in the form of a force profile that provides different force limits at different stages of the barrier run based on the barrier position. The controller may utilize a signal from a position sensor to determine where in the course of the barrier travel the barrier is at any given time in order to generate the force profile and to subsequently compare a monitored run to the force profile. In the example illustrated in FIG. 5, the force profile is divided into three primary stages corresponding to each panel section of the barrier. A different force limit is established for each of the three stages based on the local peaks in the operating parameter identified during establishment of the force limits (e.g., processes 114-120 of method 100). In addition to the three primary stages of the force profile, the terminal end of the force profile near the closed position of the door may be further refined to more closely follow the profile of the plotted operating parameter. This may provide additional sensitivity to obstructions when the barrier is nearly closed, which is when the barrier may be most likely to encounter an obstruction or cause injury. Similarly, it should be appreciated that a force profile may be defined to more closely match the contours of an initial barrier run. For example, the controller could simply offset the monitored run profile by a predetermined value along its entire length such that the force limit is consistently defined by the predetermined value above the monitored run at any position in the barrier travel.

Similar to FIG. 4 above, the monitored run shown in FIG. 5 may be viewed as the initial barrier run used to establish the force profile, but may alternatively be viewed as a subsequent barrier run (e.g., during normal operation) illustrating how the controller monitors the operating parameter over time and compared it to corresponding values of the established force profile. The controller may be configured to stop or reverse the motor immediately upon the operating parameter of the monitored run exceeding the force profile (momentary or instantaneous anomaly) or may calculate a correlation between the force profile and the monitored run profile and only stop or reverse the motor when the two profiles fall out of acceptable correlation criteria. Examples of comparing a profile from a previous successful barrier run to a current barrier run are described in U.S. Pat. No. 10,968,676 (entitled “Movable Barrier Apparatus and Methods for Responding to Barrier Travel Obstructions and Abnormalities”), which is incorporated herein by reference in its entirety.

As mentioned above, the forces encountered during movement of a barrier upon initial installation may vary from those encountered after repeated use and wear. In this regard, the profiles of monitored barrier runs may tend to drift closer and closer to the force limits over time, resulting in an increased sensitivity in detecting anomalies. In this regard, it may be desirable to for the barrier operator to be configured to identify such drift of the encountered forces and revise the force limits automatically to maintain a relatively consistent sensitivity. Alternatively, the control module of the barrier operator may include a user input control, such as a knob, to permit a user to manually adjust the sensitivity by adjusting the force limits. In this regard, the user could effectively raise or lower the force profile of FIGS. 4 and 5 within some preset range. Further examples of making adjustments to force profiles are described in U.S. Pat. No. 7,298,107 (entitled “Barrier Operator Controller with User Adjustable Force Setpoint”), which is incorporated by reference herein in its entirety.

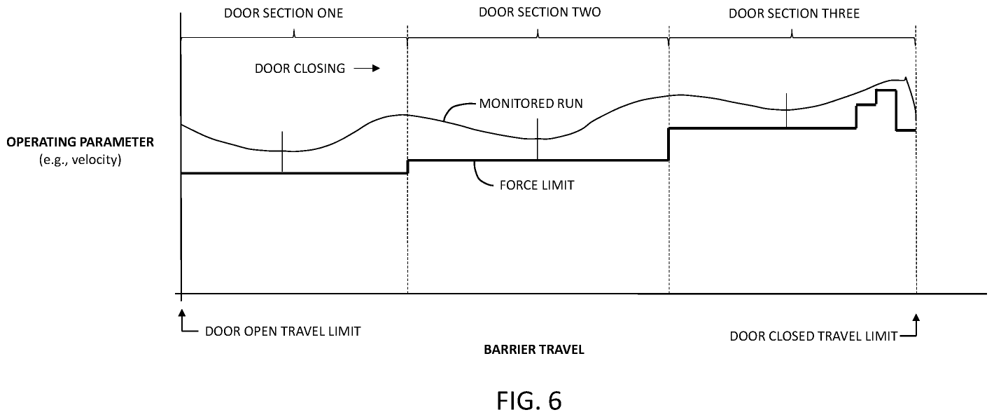

The illustrations of FIGS. 4 and 5 pertain to operating parameters which tend with increase as additional force is needed to move the barrier (e.g., motor current or applied force), hence the force limit profile being set above, or higher, than the monitored run used to set the force limits. However, it should be appreciated that some operating parameters may tend to decrease as additional force is required to move the barrier, such as velocity. FIG. 6 illustrates an example of a force limit in comparison to an operating parameter that tends to decrease as an obstruction is encountered such as velocity. The force limit in the form of a force profile in FIG. 6 establishing a minimum acceptable value as opposed to a maximum. As will be appreciated by comparing FIG. 6 to FIG. 5, the force limit values of the force profile of FIG. 6 may be based on local minimums of each panel section of the door as opposed to local maximum peaks. Additionally, one minimum force limit could be established based on the monitored run of FIG. 6 similar to the force limit of FIG. 4.

In the description, specific details have been set forth describing some examples. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure.

Elements described in detail with reference to one example, example, implementation, or application optionally may be included, whenever practical, in other examples, implementations, or applications in which they are not specifically shown or described. For example, if an element is described in detail with reference to one example and is not described with reference to a second example, the element may nevertheless be claimed as included in the second example. Thus, to avoid unnecessary repetition in the foregoing description, one or more elements shown and described in association with one example, implementation, or application may be incorporated into other examples, implementations, or application unless specifically described otherwise, unless the one or more elements would make an example or implementation non-functional, or unless two or more of the elements provide conflicting functions. Similarly, it should be understood that any particular element, including a system component or a method process, is optional and is not considered to be an essential feature of the present disclosure unless expressly stated otherwise.

Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure. In addition, dimensions and temporal relationships provided herein are for providing specific examples and it is contemplated that different sizes, dimensions, relationships and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The methods described herein are illustrated as a set of operations or processes. Not all of the illustrated processes may be performed in all examples of the methods. Additionally, one or more processes that are not expressly illustrated or described may be included before, after, in between, or as part of the example processes. In some examples, one or more of the processes may be performed by a controller and/or may be implemented, at least in part, in the form of executable code stored on non-transitory, tangible, computer or machine-readable media that when run by one or more processors may cause the one or more processors to perform one, some, or all of the processes described in relation to the methods herein. Elements illustrated in block diagrams herein may be implemented with hardware, software, firmware, or any combination thereof. One block element being illustrated separate from another block element does not necessarily require that the functions performed by each separate element requires distinct hardware or software but rather they are illustrated separately for the sake of description.

One or more elements in examples of this disclosure may be implemented in software to execute on one or more processors of a computer system such as a controller. When implemented in software, the elements of the examples of the present disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In one example, the control system supports wireless communication protocols such as Bluetooth, IrDA, HomeRF, IEEE 802.11, DECT, and Wireless Telemetry.

Note that the processes and displays presented may not inherently be related to any particular computer or other apparatus. Various general-purpose systems may be used with programs in accordance with the teachings herein, or it may prove convenient to construct a more specialized apparatus to perform the operations described. The required structure for a variety of these systems will appear as elements in the claims. In addition, the examples of the present disclosure are not described with reference to any particular programming language. It will be appreciated that a variety of programming languages may be used to implement the teachings of the present disclosure.

In some instances, well-known methods, procedures, components, and circuits have not been described in detail so as not to unnecessarily obscure aspects of the examples.

While certain exemplary examples of the present disclosure have been described and shown in the accompanying drawings, it is to be understood that such examples are merely illustrative of and not restrictive on the broad disclosure herein, and that the examples of the present disclosure should not be limited to the specific constructions and arrangements shown and described, since various other modifications may occur to those ordinarily skilled in the art.

What is claimed is:

1. A barrier operator for moving a barrier, comprising:
a motor couplable to a drive mechanism of a barrier and configured to move the barrier between open and closed positions;
a controller operably connected to the motor;
a sensor configured to monitor an operating parameter of the barrier operator associated with movement of the barrier; and
a control module including user input controls, the control module in operative communication with the controller,
wherein the controller is configured to:
receive a first user input from the control module;
initiate, in response to receipt of the first user input, operation of the motor for a first movement of the barrier to establish a first travel limit of the barrier;
receive a first signal indicative of the operating parameter from the sensor; and
generate, during the first movement of the barrier to establish the first travel limit,
a first force limit based on the first signal from the sensor.

2. The barrier operator of claim 1, wherein the first user input is a sustained input detected by the user input controls, and wherein the controller is further configured to:
at least one of cease operation or reverse a direction of the motor upon termination of the sustained input.

3. The barrier operator of claim 2, wherein the user input controls comprise a button, and wherein the sustained input is an extended press of the button, the operation of the motor occurring only while the button is pressed.

4. The barrier operator of claim 2, wherein the user input controls comprise a first user input control, and wherein the sustained input is an extended user interaction with the first user input control, the operation of the motor occurring only while the user is actively interacting with the first user input control.

5. The barrier operator of claim 1, wherein the sensor is a force sensor and the operating parameter is a force applied to move the barrier.

6. The barrier operator of claim 5, wherein the first force limit is a force profile based on a plurality of forces applied to move the barrier during the first movement of the barrier, each force of the plurality of forces corresponding to a respective position of the barrier.

7. The barrier operator of claim 5, wherein the first force limit is a single value based on a maximum force applied to move the barrier during the first movement of the barrier.

8. The barrier operator of claim 1, wherein the sensor is a current sensor and the operating parameter is a current supplied to the motor to move the barrier during the first movement of the barrier.

9. The barrier operator of claim 8, wherein the controller is further configured to:
determine a force applied to move the barrier based on the current supplied to the motor.

10. The barrier operator of claim 9, wherein the first force limit is a current profile comprising a plurality of currents supplied to the motor during the first movement of the barrier, each current of the plurality of currents corresponding to a respective position of the barrier.

11. The barrier operator of claim 8, wherein the first force limit is a single value based on a maximum current supplied to the motor during the first movement of the barrier.

12. The barrier operator of claim 1, wherein the sensor is a position sensor and the operating parameter is a velocity of the barrier during the first movement of the barrier.

13. The barrier operator of claim 12, wherein the first force limit is a velocity profile comprising a plurality of minimum velocities corresponding to a plurality of positions of the barrier.

14. The barrier operator of claim 12, wherein the first force limit is a single value based on a minimum velocity of the barrier during the first movement of the barrier.

15. The barrier operator of claim 1, wherein the first signal is a continuous stream of information transmitted by the sensor to the controller during the first movement of the barrier.

16. The barrier operator of claim 1, wherein the controller is further configured to:
generate a second force limit based on the first force limit, the second force limit corresponding to movement of the barrier in a direction opposite to a direction of the first movement of the barrier.

17. The barrier operator of claim 1, wherein the controller is further configured to:
receive a second user input from the control module;
initiate, in response to receipt of the second user input, operation of the motor for a second movement of the barrier to establish a second travel limit of the barrier;
receive a second signal indicative of the operating parameter from the sensor; and
generate, during the second movement of the barrier to establish the second travel limit, a second force limit based on the second signal from the sensor.

18. The barrier operator of claim 1, wherein the first movement of the barrier is an opening movement beginning from a closed position of the barrier, and wherein the first travel limit is an open limit position of the barrier.

19. The barrier operator of claim 18, wherein the first user input is a momentary input.

20. The barrier operator of claim 1, wherein the first movement of the barrier is a closing movement beginning from an open position of the barrier, and wherein the first travel limit is a closed limit position of the barrier.

21. The barrier operator of claim 1, wherein the controller is further configured to:
monitor the operating parameter during movement of the barrier subsequent to the first movement of the barrier;
compare the operating parameter during the movement of the barrier subsequent to the first movement of the barrier to the first force limit; and
at least one of cease operation or reverse a direction of the motor when the operating parameter exceeds the first force limit.

22. The barrier operator of claim 1, wherein the controller is further configured to:
detect whether an external entrapment device is in operative communication with the barrier operator;
set, when the external entrapment device is not detected, a reduced maximum operating speed of the motor.

23. A method for establishing a force limit for a barrier operator, comprising:
receiving a first user input from a control module of a barrier operator;
initiating, in response to receipt of the first user input, operation of a motor of the barrier operator for a first movement of a barrier to establish a first travel limit of the barrier;
receiving a first signal indicative of an operating parameter of the barrier operator from a sensor; and
generating, during the first movement of the barrier to establish the first travel limit, a first force limit based on the first signal from the sensor.
